(19) United States
(12) Patent Application Publication
(10) Pub. No.: US 2008/0225874 A1
(43) Pub. Date: Sep. 18, 2008

(54) Stateful packet filter and table management method thereof

(76) Inventor: Seoung-Bok Lee, Yongin-si (KR)

Correspondence Address: ROBERT E. BUSHNELL, 1522 K STREET NW, SUITE 300, WASHINGTON, DC, 20005-1202, US

(21) Appl. No.: 12/073,999

(22) Filed: Mar. 12, 2008

(30) Foreign Application Priority Data
Mar. 13, 2007 (KR) 10-2007-0024526

(51) Int. Cl. H04L 12/56

(52) U.S. Cl. 370/412

(57) ABSTRACT

A stateful packet filter and a table management method thereof The stateful packet filter includes an index buffer storing a session table index address from a session table, which is searched for determining a session of a received packet when a packet is received; and a table manager updating a state table by using the session table index address, stored in the index buffer, as a state table address value.

### CLAIM OF PRIORITY

This application makes reference to, incorporates the same herein, and claims all benefits accruing under 35 U.S.C. §119 from an application for STATEFUL PACKET FILTER AND TABLE MANAGEMENT METHOD THEREOF earlier filed in the Korean Intellectual Property Office on Mar. 13, 2007 and there duly assigned Serial No. 2007-0024526.

### BACKGROUND OF THE INVENTION

1. Field of the Invention

The present invention relates to a stateful packet filter and a table management method thereof, and more particularly, to a stateful packet filter and a table management method therefor preventing a transmission delay between both Transmission Control Protocol (TCP) endpoints from being caused by a firewall system.

2. Description of the Related Art

As well known in the art, a stateful packet filter using a Ternary Content Addressable Memory (TCAM) manages all Transmission Control Protocol (TCP) packets from session connection to session termination, by establishing a session table.

As a preliminary matter, it should be noted that static IP filtering, known as “stateless filtering”, which is designed to provide basic traffic routing, is characterized by low overhead and high throughput, and low cost, and is frequently included with router configuration software. Stateless filtering either passes or drops (i.e., discards) each packet without regard to passage of earlier packets because static IP filtering stores no information about earlier packets. Holes in the firewall of static filters are permanent. Consequently, stateless filters permit direct connections between a network and external Internet connections, are cumbersome to maintain for a complex network, must be specifically altered to forestall particular Internet attacks, and are unable to provide authentication.

In order to address these security problems with stateless filtering and provide an intelligent firewall, efforts have been made to develop dynamic filtering, known as “stateful filtering”, in which individual determinations are made to pass (i.e., to “forward”) or to drop a packet. Stateful filtering contemplates either pure packet filtering or, alternatively, packet filtering which uses proxies which serve as intelligent intermediaries between hosts for a network and external Internet connections.

TCP is a sliding window protocol that is implemented as a finite state machine, and that establishes virtual full duplex connections, known as “endpoints”, between each IP address and a TCP port number. TCP contemplates both timeouts and retransmissions, and may be used to guarantee delivery of packets. Byte streams of data are forwarded in segments, and window size determines the number of bytes of data that may be sent before an acknowledgment from the recipient is required.

Content-addressable memory (CAM) is a special type of computer memory employed by very high speed searching applications. Unlike standard computer memories (for example, a random access memory) in which users supply a memory address and the random access memory may return the data word being stored at that address, a CAM is specially designed such that users may supply a data and the CAM may search the entire memory space to see whether this data is stored in the CAM. Ternary CAM (TCAM) has an additional flexibility of searching and allows a third matching state of “Do Not Care” for one or more bits in the stored data. For example, a ternary CAM may have a stored word of “10XX0” which may match any of the four searched words “10000”, “10010”, “10100”, or “10110”.

A general data packet is input after TCP three-way connection setup exchange for TCP session connection is ended, in which the filter identifies the presence of an existing session via simple lookup. In the case of a TCP three-way connection setup packet, a procedure such as addition and/or lookup is required for a session table. For a state table, a new state value is added to a present session and a previous session is updated with a present session.

In the stateful packet filter having two session tables and two state tables for the same session, which is set to both TCP endpoints, a large number of TCAM accesses are required for a TCP three-way initial connection setup packet.

In a contemporary TCP three-way handshake, in order to update the state value of a session, a process of updating the state value of a session includes procedures for forming a search key, performing TCAP lookup using the search key, obtaining an index address, and finding the state table address of an static random access memory (SRAM).

Furthermore, the cycle of a TCP three-way table operation data is much longer than that of a general data, and thus causes a following problem. When many TCP three-way connection requests are temporarily input at the same time, even though a TCP server actually sends a Synchronization/Acknowledgment (SYN/ACK) packet as a normal response to a Synchronization (SYN) packet, a delay in TCAM table registration may cause the SYN/ACK packet transmitted from the TCP server to be discarded as an unregistered session.

The packet discarded as above has a significant effect to the processing capacity of a system constructed according to network input line speed of a firewall system, which uses the stateful packet filtering.

In particular, either TCP session concurrent connection capacity test or TCP maximum session rate test is generally used as a major index of the firewall processing capacity. As the line speed increases, the problem such as the delay in table registration has a larger effect on measurement items and also degrades the entire processing capacity of the firewall system, thereby causing a transmission delay between both TCP endpoints.

### SUMMARY OF THE INVENTION

It is, therefore, an object of the present invention to provide an improved stateful packet filter and a table management method thereof to overcome the disadvantages stated above.

It is another object of the present invention to provides a stateful packet filter and a table management method therefor, by which, when a large number of TCP three-way connection requests are temporarily input at the same time, the number of TCAM accesses necessary for TCAM table management may be reduced to increase the processing capacity of a TCP three-way connection setup table, thereby preventing a transmission delay between both TCP endpoints from being caused by a firewall system.

According to an aspect of the present invention, the stateful packet filter includes an index buffer storing a session table index address from a session table, which is looked up when a packet is received; and a table manager updating a state table using the session table index address, stored in the index buffer, as a state table address value.

The stateful packet filter may further include an operation queue for storing operational data for the stable table and the session table for Transmission Control Protocol (TCP) three-way connection setup.

The index buffer may have the session table index address only when the session table index address corresponds to a packet stored in the operation queue, and the size of the packet equals to and has one-to-one correspondence with the operation queue.

According to another aspect of the present invention, the table management method of a stateful packet filter includes procedures of receiving a packet, generating a search key, and looking up the session table; identifying, according to a matching signal from the session table, whether or not an entry registered in the session table is present; if the entry registered in the session table is present, identifying whether or not the received packet is a Transmission Control Protocol (TCP) three-way packet and, concurrently, storing a session table index address from the session table; if the PCT three-way packet is normal, storing operation data for the packet; and updating a state table using the stored session table index address as a state table address value.

In the procedure of receiving a packet, generating a search key, and looking up (i.e., addressed and searched) the session table, the session table may be initially and unconditionally looked up in order to examine whether or not the packet input to the stateful packet filter is already present.

If the packet is not in a TCP three-way stage but in a general data stage as a result of the looking up of the session table, a state table value corresponding to the session table index address, obtained from the result of the looking up of the session table, may be a state value indicating a TCP connection setup completion.

The table management method may further include a procedure of allowing the packet to pass when the received packet is not the TCP three-way connection packet.

The table management method may further include a procedure of discarding the packet when the TCP three-way packet is not normal,.

In the procedure of storing operation data for the packet, when the PCT three-way packet is normal, the operation data may include a packet identifier, an Internet Protocol (IP) source address, an IP destination address, a TCP source port, a TCP destination port, a protocol field, a present state value and a Sequence/Acknowledgment (Seq/Ack) number.

When the entry registered in the session table is not present in the procedure of identifying, according to a matching signal from the session table, whether or not an entry registered in the session table is present, the table management method may further include a procedure of identifying whether or not the received packet is a Synchronization (Syn) packet, and discarding the received packet if the received packet is not the synchronized packet.

When the received packet is the synchronization packet, the table management method may further include a procedure of searching for a space in the session table, generating a session table session, and writing a present state value in the state table.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating the structure of a stateful packet filter using a hardware logic constructed according to the present invention; and

FIG. 2 is a flowchart illustrating a TCAM table management process in the stateful packet filter constructed according to the present invention.

### DETAILED DESCRIPTION OF THE INVENTION

The present invention will now be described more fully hereinafter with reference to the accompanying drawings, in which preferred embodiments thereof are shown. Reference now should be made to the drawings, in which the same reference numerals and signs are used throughout the different drawings to designate the same or similar components. In the following description of the present invention, a detailed description of known functions and components incorporated herein will be omitted when it may make the subject matter of the present invention rather unclear.

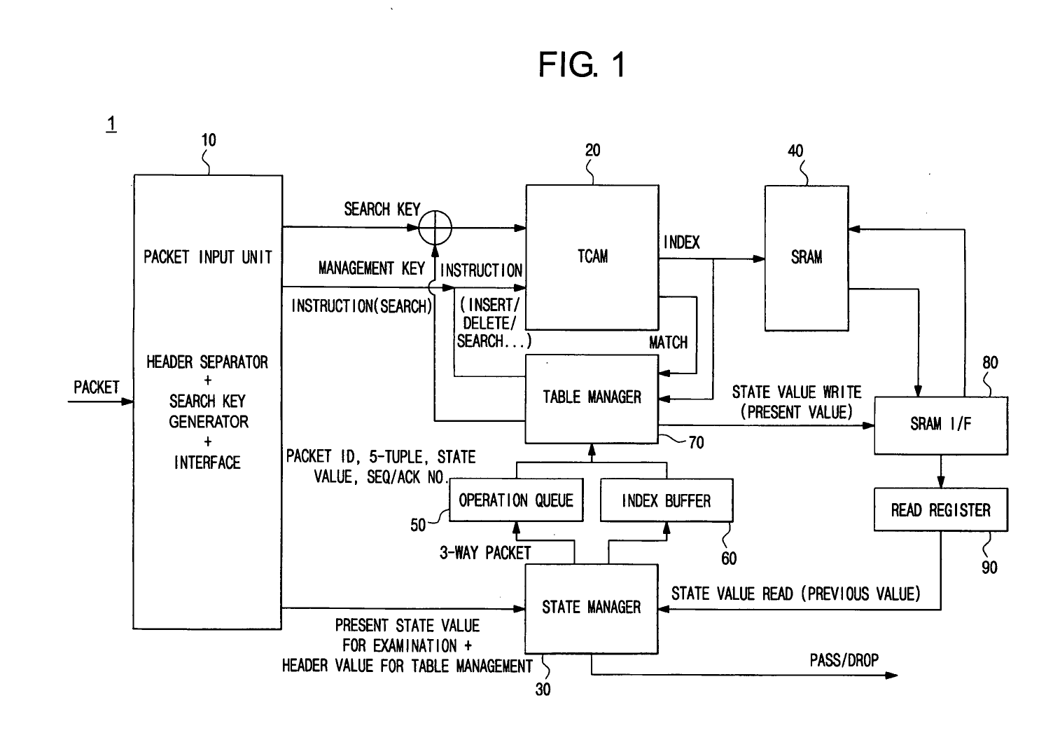

FIG. 1 is a block diagram illustrating the structure of a stateful packet filter using a hardware logic constructed according to the present invention.

As shown in FIG. 1, packet filter 1 of the present invention includes a packet input unit 10, a Ternary Content Addressable Memory (TCAM) 20, a state manager 30, an Static random access memory (SRAM) 40, an operation queue 50, an index buffer 60, a table manager 70, an SRAM interface 80 and a read register 90.

Packet input unit 10 receives a packet data, separates a header from the received packet data by a header separator, generates a search key by a search key generator, sends the search key to TCAM 20, and sends partially separated header fields and a generated packet identifier (ID) to state manager 30.

TCAM 20 has a session table that receives the search key from packet input 10, and TCAM 20 is looked up (i.e. searched) to determine the session of the received packet, or a table entry of the session table is added to the session table, or deleted from the session table by using the search key depending on the type of the search key. SRAM 40 has a state table and outputs a state value matching the address of SRAM 40 constructed according to an index address received from TCAM 20. A table entry is a list of session state information stored in the session table.

State manager 30 receives header fields and packet IDs from packet input 10 to mutually identify and examine a present TCP flag field and a state value, obtained by looked-up result by TCAM 20 from SRAM 40. In the case of a normal TCP three-way packet, an operation data including a packet ID, a management key and state values to be updated are stored in operation queue 50.

State manager 30 stores an index address of TCAM 20 in index buffer 60. The index address of TCAM 20 is obtained by an unconditional lookup during the event of packet reception.

Operation queue 50 stores the operation data of an SRAM state table and a TCAM session table for TCP three-way connection setup. Here, the operation data includes a packet ID, which is sent along with accept/discard information, related with the passage of the packet, via packet forwarding. The operation data also includes an Internet Protocol (IP) source address, an IP destination address, a TCP source port, a TCP destination port, a protocol field (5-Tuple), a present state value and a Sequence/Acknowledgment (Seq/Ack) number, which are used for session table management.

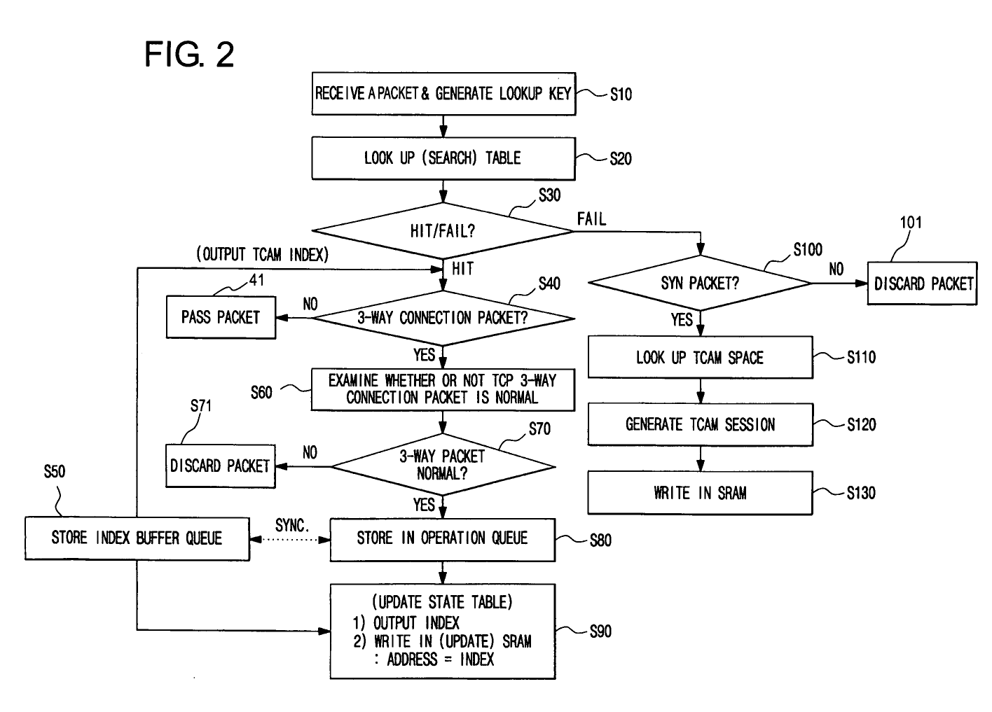

In the case of the table operation data for updating the state value during the TCP three-way connection setup procedure, index buffer 60 is synchronized with operation queue 50 (as shown in FIG. 2) to steadily provide sequential outputs to table manager 70.

Table manager 70, based on information from operation queue 50 and index buffer 60, generates an instruction for the management of a TCAM table and a management key corresponding thereto, and outputs the instruction and management key to a TCAM table. Examples of the management key may include a key for adding a specific entry address of TCAM 20 to the session table of TCAM 20, a key for deleting a table entry from TCAM 20, a search key for searching session table stored in TCAM 20 in order to determine the session of the received packet in the state table stored in SRAM 40 prior to updating state value in SRAM 40.

Furthermore, when a “match” signal is received from TCAM 20, table manager 70 fetches a next operation from operation queue 50 and index buffer 60 and executes the next operation. Here, the match signal refers to a signal indicating that the session of the received packet is found in the session table stored in TCAM 20. In the case of updating state value except for the initial SYN packet, table manager 70 updates the state value by directly writing the index address received from index buffer 60 into the state table stored in SRAM 40 unlikely to a contemporary TCAM lookup.

SRAM interface 80 processes input/output of the state value of the SRAM to/from table manager 70 and state manager 30.

Write register 90 sends the state value from SRAM interface 80 to state manager 30.

FIG. 2 is a flowchart illustrating a TCAM table management process in the stateful packet filter constructed according to the present invention.

As shown in FIG. 2, at beginning of the process, the stateful packet filter receives a packet and generates a search key, necessary to look up (i.e. search) a session table stored in TCAM 20 (during step S110) for determining the session of the received packet.

Next, for all packets input into the stateful packet filter located between both TCP endpoints, TCAM 20 is initially and unconditionally looked up in order to examine whether or not a packet is a previously-existing session (during step S20).

When a packet is not in a TCP three-way stage but in a general data stage, a state value indicating “TCP connection setup completion” is sent as a state table value corresponding to the index address of TCAM 20 based on the looked-up result from TCAM 20.

Next, it is identified whether or not an entry registered in the session table is present according to a match signal sent from table manager 70 to TCAM 20 (during step S30). In step S30, “HIT” refers to a condition where the session table is present and “FAIL” refers to a condition where the session table is not present.

If the entry registered in the session table is present (i.e. the HIT condition), it is identified whether or not the received packet is a TCP three-way connection packet (during step S40), and the TCAM index from TCAM 20 is concurrently stored in the buffer queue (during step S50).

That is, the index address from TCAM 20 is stored in index buffer 60 when the TCAM looked-up result is HIT, so that the index address may be used as a state table address value later during updating the state value.

If the received packet is identified as a TCP three-way connection packet in S40, the TCP three-way connection packet is examined to identify whether or not the TCP three-way connection packet is normal (during step S60). If the received packet is not a TCP three-way connection packet in S40, the packet is allowed to pass (during step S41).

Next, the TCP three-way connection packet is examined to identify whether or not the TCP three-way connection packet is normal (during step S70). If the TCP three-way connection packet is not normal, the packet is discarded during step S71. If the TCP three-way connection packet is normal, an operation data for the three-way packet is stored in operation queue 50 (during step S80). Here, the operation data includes a packet ID, 5-Tuple, a present state value, Seq/Ack number and other related values.

In subsequence, the state table is updated using the TCAM index address, which is stored in TCAM index buffer 60 during step S90. The present sate value is written and updated in SRAM 40 using the TCAM index, stored in the index buffer 60, as the state table address value.

In a contemporary structure, the session table stored in TCAM 20 is looked up in order to obtain the index address even in the case of the table operation data for state value update, and thus a operating time cycle longer than that of the present invention is required. In the present invention, on the other hand, the TCAM looked-up cycle is not necessary since the state table is updated using the TCAM index address stored in index buffer 60.

At a specific point after the index address is already stored in the buffer queue, if the received packet is not supposed to be stored in the operation queue, that is, the received packet is not a TCP three-way connection packet or is a TCP three-way packet to be discarded as the result of the examination, the stored index address is reset as a null value.

Index buffer 60 has only a TCAM index address corresponding to a packet to be stored in the operation queue, and has same size as and has always one-to-one correspondence to the operation queue.

If the operation data requesting TCP three-way connection setup, read from the table manager, is a table operation data for state value update, it is updated in the state table via the SRAM interface using the TCAM index address of the index buffer. In the case of other packets, the index buffer is not used for a different TCAM index address such as a blank index address that is the result of TCAM space lookup for adding to the session table at initial SYN state registration.

In the procedure of identifying whether or not the entry registered in the session table is present (S30), if the entry registered in the session table is not present (i.e. the FAIL condition), it is identified whether or not the received packet is a Synchronization (SYN) packet (during step S100). IF the received packet is not a SYN packet, the received packet is discarded (during step S101).

If the received packet is a SYN packet, the memory space of TCAM 20 is searched (during step S110) to generate a TCAM session (during step S120), and the present state value is written into SRAM 40 via SRAM interface 80 (during step S130). The procedures S110 to S130 may be repeated in a reverse order.

According to the present invention as set forth above, when a large number of TCP three-way connection requests are temporarily input at the same time, the number of TCAM access required for the management of the TCAM table may be reduced in order to reduce the number of total session table management cycles, thereby preventing an overflow in the operation queue.

Furthermore, the processing rate of the TCP three-way connection setup table is raised to prevent a transmission delay between both TCP endpoints from being caused by a firewall system. Moreover, the raised processing rate may further improve concurrent TCP connection speed of the firewall, thereby improving the processing capacity of the firewall over the prior art.

While the present invention has been shown and described in connection with the preferred embodiments, it will be apparent to those skilled in the art that modifications and variations can be made without departing from the spirit and scope of the present invention as defined by the appended claims.

What is claimed is:

1. A stateful packet filter, comprising:
an index buffer storing a session table index address from a session table which is searched for determining a session of a received packet, when the received packet is received by said packet filter; and
a table manager updating a state table by using the session table index address, stored in the index buffer, as a state table address value.

2. The stateful packet filter of claim 1, further comprising:
an operation queue storing an operation data of the stable table and the session table for a setup process of a transmission control protocol three-way connection.

3. The stateful packet filter of claim 2, with the index buffer further comprising the session table index address only when the session table index address corresponds to a packet stored in the operation queue, and with the size of the index buffer being equal to and having one-to-one correspondence to the operation queue.

4. A table management method of a stateful packet filter, comprising:
receiving a packet, generating a search key, and searching a session table;
identifying, according to a matching signal from the session table, whether or not an entry registered in the session table is present;
when the entry registered in the session table is present, identifying whether or not the received packet is a transmission control protocol three-way packet, and concurrently, storing a session table index address from the session table in a buffer queue;
when the received packet is a transmission control protocol three-way packet and the transmission control protocol three-way packet is normal, storing an operation data for the received packet; and
updating a state table by using the stored session table index address as a state table address value.

5. The table management method of claim 4, in which the step of receiving a packet, generating a search key, and looking up the session table, further comprises:
initially and unconditionally searching the session table in order to examine whether or not the received packet is already present.

6. The table management method of claim 5, in which, when the packet in a general data stage which is different from a transmission control protocol three-way stage based on a searched result of the session table, a state table value corresponding to the session table index address, obtained from the searched result of the session table, is a state value indicating a completion of setup process of transmission control protocol connection.

7. The table management method of claim 4, further comprising:
when the received packet is not the transmission control protocol three-way connection packet, allowing the received packet to pass.

8. The table management method of claim 4, further comprising:
when the transmission control protocol three-way packet is not normal, discarding the packet.

9. The table management method of claim 4, in which, in the step of storing operation data for the packet, when the transmission control protocol three-way packet is normal, the operation data comprising:
a packet identifier, an Internet protocol source address, an Internet protocol destination address, a transmission control protocol source port, a transmission control protocol destination port, a protocol field, a present state value and a sequence/acknowledgment number.

10. The table management method of claim 4, in which when the entry registered in the session table is not present, the step of identifying, according to a matching signal from the session table, whether or not an entry registered in the session table is present, further comprising:
identifying whether or not the received packet is a synchronization packet, and
when the received packet is not the synchronized packet, discarding the received packet.

11. The table management method of claim 10, further comprising:
when the received packet is the synchronization packet, searching for a space in the session table, generating a session table session, and writing a present state value into the state table.

12. A stateful packet filter, comprising:
a packet input unit receiving an input packet, generating a search key, sending the search key to a ternary content addressable memory;
the ternary content addressable memory storing a session table;
a static random access memory storing a state table;
an index buffer storing a session table index address from the session table which is searched for determining a session of the received packet, when the received packet is received by said packet filter;
a state manager examining a state value of the received packet according to the searched result of the state table stored in static random access memory by the ternary content addressable memory; and
a table manager updating the state table by using the session table index address, stored in the index buffer, as a state table address value.
